(19) United States
(12) Patent Application Publication
(10) Pub. No.: US 2025/0201502 A1
(43) Pub. Date: Jun. 19, 2025

(54) SWITCHING CHAMBER FOR A SWITCHING DEVICE AND SWITCHING DEVICE

(71) Applicant: TDK Electronics AG, Muenchen (DE)

(72) Inventors: Robert Hoffmann, Berlin (DE); Robert Minkwitz, Berlin (DE)

(21) Appl. No.: 18/849,707

(22) PCT Filed: Apr. 4, 2023
(86) PCT No.: PCT/EP2023/058858

§ 371 Date: Sep. 23, 2024

(30) Foreign Application Priority Data
Apr. 14, 2022 (DE) 10 2022 109 265.8

(51) Int. Cl. H01H 50/02

(52) U.S. Cl. CPC H01H 50/023; H01H 2050/025

(57) ABSTRACT

In an embodiment a switching chamber for a switching device includes at least a switching chamber base having, on an inner side facing an interior of the switching chamber, a bottom surface with a web structure, which projects out of the bottom surface into the interior.

### CROSS-REFERENCE TO RELATED APPLICATIONS

This patent application is a national phase filing under section 371 of PCT/EP2023/058858, filed Apr. 4, 2023, which claims the priority of German patent application 102022109265.8, filed Apr. 14, 2022, each of which is incorporated herein by reference in its entirety.

### TECHNICAL FIELD

A switching chamber for a switching device and a switching device are specified.

### BACKGROUND

The switching device is configured in particular as an electromagnetically operated, remotely actuated switch that can be operated by an electrically conductive current. The switching device can be activated via a control circuit and can switch a load circuit. In particular, the switching device can be configured as a relay or as a contactor, in particular as a power contactor. Particularly preferably, the switching device can be configured as a gas-filled power contactor.

A possible application of such switching devices, in particular power contactors, is the opening and disconnecting of battery circuits, for example in motor vehicles such as electrically or partially electrically powered vehicles. These can be, for example, purely battery-powered vehicles (BEV: “Battery Electric Vehicle”), hybrid electric vehicles (PHEV: “Plug-in Hybrid Electric Vehicle”) that can be charged via a socket or charging station, and hybrid electric vehicles (HEV: “Hybrid Electric Vehicle”). As a rule, both the positive and negative contacts of the battery are disconnected using a power contactor. This disconnection takes place during normal operation, for example when the vehicle is at rest, as well as in the event of a fault such as an accident or similar. The main task of the power contactor is to disconnect the vehicle from the power supply and interrupt the flow of current. Particularly in the event of a fault, switching arcs occur when the current is interrupted. These arcs must be extinguished using suitable measures in order to safely interrupt the current flow and prevent destruction of the switch. The aim when designing the switch components is a low price, simple and fast manufacturability and a long service life, i.e. a large number of switching cycles.

To extinguish electric arcs, a hydrogen-containing gas filling and permanent magnets, so-called blowing magnets, arranged in the region of the occurring arcs are usually used, which can deflect the arcs. For example, the publication EP 1 168 392 A1 describes such measures.

However, switching arcs and their extinguishing can lead to sputtering of the contact materials of the switching contacts. This effect, also known as burn-off, can cause sputtered contact materials to be deposited on the walls of the switching chamber in which the switching contacts are arranged. On the other hand, so-called melting beads can also form, which fall to the bottom of the switching chamber and which can migrate in the switching chamber during further operation due to movements of the switching device in the application as well as due to vibrations and suction effects, for example during gas exchange when switching on and off. As a result, there is a risk that melting beads can obstruct or block mechanical components, for example, so that the mechanically moving parts of the switching device can slow down or even jam completely during the switching process. To protect the mechanics against this, very tight guides to the switching chamber have been used up to now, for example, but these can lead to longer evacuation and gas filling times.

The publications DE 11 2019 005 667 T5 and DE 10 2009 027 844 A1 describe an electromagnetic relay.

### SUMMARY

Embodiments provide a switching chamber for a switching device. Further embodiments provide a switching device with such a switching chamber.

According to at least one embodiment, a switching chamber comprises at least a switching chamber base. In particular, the switching chamber can have an interior. Regions and surfaces of the switching chamber base that face the interior are arranged on an inner side of the switching chamber base. Regions and surfaces of the switching chamber base that do not face the interior can be arranged on an outer side of the switching chamber base. The switching chamber can furthermore have a switching chamber cover, which can enclose the interior together with the switching chamber base.

According to at least one further embodiment, a switching device comprises such a switching chamber. In particular, the switching chamber base can be that part of the switching chamber which forms a lower part of the switching chamber as seen along the direction of gravity during normal installation of the switching device in accordance with its use, so that any loose parts present in the switching chamber are highly likely to be found on the switching chamber base due to the direction of gravity.

According to a further embodiment, the switching device has at least one fixed contact and at least one movable contact. The at least one fixed contact and the at least one movable contact are intended and configured to switch on and off a load circuit that can be connected to the switching device. The movable contact can be switched in the switching device between a non-through-connecting state and a through-connecting state such that, in the non-through-connecting state of the switching device, the movable contact is spaced apart from the at least one fixed contact and is thus galvanically isolated and, in the through-connecting state, has a mechanical contact to the at least one fixed contact and is thus galvanically connected to the at least one fixed contact. Particularly preferably, the switching device has at least two fixed contacts which are arranged separately from one another in the switching device and which, in this way, can be electrically conductively connected to one another or electrically separated from one another by the movable contact, depending on the state of the movable contact. The features described below for a fixed contact can apply particularly preferably to each fixed contact of the switching device.

According to a further embodiment, the switching device has a housing in which the switching chamber as well as the movable contact and the at least one fixed contact are arranged. In particular, the movable contact can be arranged completely in the housing. The fact that a fixed contact is arranged in the housing can mean in particular that at least the contact region of the fixed contact, which is in mechanical contact with the movable contact in the through-connecting state, is arranged inside the housing. To connect a supply line of a circuit to be switched by the switching device, a fixed contact arranged in the housing can be electrically contacted from the outside, i.e. from outside the housing. For this purpose, a fixed contact arranged in the housing can protrude with a part out of the housing and have a connection option for a supply line outside the housing.

According to a further embodiment, the contacts are arranged in a gas atmosphere in the housing. This can mean in particular that the movable contact is arranged completely in the gas atmosphere in the housing and that furthermore at least parts of the fixed contact or contacts, such as the contact region or regions of the fixed contact or contacts, are arranged in the gas atmosphere in the housing. Accordingly, the switching device can particularly preferably be a gas-filled switching device such as a gas-filled contactor.

According to a further embodiment, the contacts, i.e. the movable contact completely as well as at least parts of the fixed contact or contacts, are arranged in the switching chamber inside the housing, in which the gas, i.e. at least part of the gas atmosphere, is located. The gas can have a proportion of greater than or equal to 20% H₂ and preferably a proportion of greater than or equal to 50% H2 and less than or equal to 100% H₂. In addition to hydrogen, the gas can comprise an inert gas, particularly preferably N₂ and/or one or more noble gases. The gas, particularly in the switching chamber, can improve arc extinguishing.

According to a further embodiment, at least one blowing magnet is arranged in or on the switching chamber, which can be formed particularly preferably by a permanent magnet. Furthermore, several blowing magnets can also be present. If the switching device is switched off under load, i.e. if the movable contact and the one or more fixed contacts are spatially separated while the load current is still flowing, the resulting arc is deflected by the blowing magnet(s) and thus extended and driven out of the contact region. This can also improve arc extinction.

According to a further embodiment, the switching chamber, for example the switching chamber cover or the switching chamber base, has at least one opening, wherein the at least one fixed contact can project through the opening into the interior of the switching chamber, so that a part of the at least one fixed contact can be located outside the switching chamber and another part of the at least one fixed contact can be located inside the switching chamber and thus in the interior of the switching chamber. If the switching device has several fixed contacts, the switching chamber can preferably have a corresponding opening for each of the fixed contacts, for each of which the aforementioned applies.

The switching chamber cover can, for example, be shaped like a cap and be in one or more parts. The switching chamber base can, for example, be essentially plate-like and also be in one or more parts. Particularly preferably, at least the switching chamber base is formed in one piece, i.e. as a coherent part that is not manufactured by joining several parts that are manufactured independently of one another. The term “plate-like” can refer to an essentially flat design compared to a cap-shaped design. However, raised or recessed structures such as webs, grooves and circumferential edge parts can be present. “Plate-like” can therefore also mean shell-shaped, for example. Furthermore, it is also possible that the switching chamber base and the switching chamber cover are both cap-shaped. Irrespective of the specific shape of the switching chamber cover and the switching chamber base, they can be arranged in a particularly preferred manner in relation to each other to form the switching chamber in such a way that the interior space is formed, in which the switching processes described above take place.

According to a further embodiment, the switching chamber comprises a plastic material and/or a ceramic material. Particularly preferably, the switching chamber base can be made with or from a plastic material. Particularly preferably, the switching chamber base is made entirely of a plastic material. For example, the switching chamber base can be configured as a molded part, i.e. as a one-piece part, which can be manufactured using a molding process such as injection molding or compression molding. The switching chamber cover can, for example, be made with or from a ceramic material or alternatively also from a plastic material.

Particularly preferably, the plastic material can comprise one or more materials selected from polyoxymethylene (POM), polybutylene terephthalate (PBT) and polyamide (PA). Preferably, PA46 can be used as the polyamide. POM is a semi-crystalline, largely linear thermoplastic that can be produced by chain polymerization or chain copolymerization and has the recurring building block —CHR—O—, wherein R denotes an organic radical. Particularly preferably, the plastic material comprises the structure (CH₂O)ₙ, i.e. with hydrogen as the radical R, or is formed thereby. Accordingly, the plastic material can be characterized by a comparatively low carbon content and a very low tendency to form graphite. Due to the equal proportions of carbon and oxygen, particularly in the case of (CH₂O)ₙ, predominantly gaseous CO and H₂ can be formed during heat-induced and, in particular, arc-induced decomposition. Consequently, hardly any conductive wall coatings are formed and the additional hydrogen can increase arc extinction.

Furthermore, the plastic material can contain a filler, in particular a glass material, for example in the form of glass fibers, dispersed in the plastic material. The mechanical stability and temperature stability can be influenced and preferably improved by such a filler. It is particularly preferred that the plastic material has a filler content, for example a glass fiber content, of less than or equal to 50% by mass.

Particularly preferably, the plastic material is selected, for example by selecting a suitable polymer material and by selecting a suitable proportion of a filler, so that it has sufficient mechanical and thermal stability under normal operating conditions of the switching device and at the same time has a softening temperature or melting temperature which is selected so that contact material which is still hot and which gets onto the switching chamber base, for example in the form of melting beads, as a result of arc-induced burning of the switching contacts, can soften the plastic material so that, for example, melting beads can at least partially melt into the switching chamber base. This can restrict the freedom of movement of melting beads on the switching chamber base. For example, the material of the switching chamber base can have a melting temperature of greater than or equal to 250° C. and less than or equal to 350° C.

According to a further embodiment, the switching chamber base has a bottom surface with a web structure on the inside facing the interior of the switching chamber, which protrudes out of the bottom surface into the interior. In particular, the bottom surface can be the region of the switching chamber base that is uncovered within the interior of the switching chamber when the switching chamber is fully assembled and is therefore accessible in principle, for example for melting beads. The bottom surface can therefore be, for example, the region of the switching chamber base on the inside, which is surrounded by a circumferential and, for example, raised edge structure.

In particular, the web structure can be raised, i.e. protrude from the bottom surface in relief. The web structure can, for example, have at least one web that extends over the bottom surface. In particular, the web structure can be configured in such a way that the freedom of movement of loose parts on the switching chamber base can be reduced.

The web structure can, for example, be configured in such a way that the bottom surface has a plurality of bottom regions separated from one another by the web structure. A loose part, such as a melting bead, can preferably be prevented from moving from one bottom region to another bottom region separated from it by the web structure, at least under normal operating conditions. This can be achieved by restricting the freedom of movement of melting beads on the bottom surface of the switching chamber base, at least under normal operating conditions. Preferably, the bottom regions separated from each other lie in the same plane and thus define this plane. In other words, the bottom surface would preferably be flat without the web structure. For example, the plane in which the bottom regions lie can be arranged perpendicular to the direction of gravity in a normal installation of the switching device according to use. In this case, the direction of gravity can also be referred to as the vertical direction. A direction perpendicular to the plane defined by the bottom regions can accordingly also be referred to as the vertical direction. Furthermore, the vertical direction can in particular also be the direction of movement along which the movable contact moves during the switching movement. Furthermore, the vertical direction can also correspond to the axial direction of a shaft by means of which the movable contact is moved. A longitudinal direction can preferably be defined by an arrangement direction of two fixed contacts that is perpendicular to the vertical direction. A transversal direction can be perpendicular to the vertical direction and perpendicular to the longitudinal direction. Thus, the longitudinal direction and the transversal direction can span the plane in which the bottom regions are located. For example, the switching chamber base can have a substantially rectangular shape when viewed along the vertical direction. In this case, the longitudinal direction can run along the longer side of the rectangular shape and the transversal direction along the shorter side of the rectangular shape, even independently of the arrangement of fixed contacts.

The web structure and in particular the at least one web can have a height of greater than or equal to 0.5 mm and less than or equal to 5 mm and preferably greater than or equal to 1 mm and less than or equal to 3 mm. Here and in the following, unless otherwise stated, height specifications refer to a distance to a bottom region measured in the vertical direction.

The web structure can also have a plurality of webs and particularly preferably at least two intersecting webs. Furthermore, the web structure can have webs arranged in a grid-like manner, i.e. at least one web in the longitudinal direction which crosses two or more webs extending transversely thereto, i.e. webs extending along the transversal direction, for example. In other words, the web structure may, for example, have at least one longitudinal web and at least two transversal webs. In addition, the web structure can also have one or more webs that run at an angle to the longitudinal direction and at an angle to the transversal direction. For example, the web structure can form a honeycomb structure formed by several webs, for example with rectangular or hexagonal honeycombs. By means of the web structure, the bottom surface, which has a total area, can particularly preferably be divided into a plurality of bottom regions separated from one another, each of the plurality of bottom regions having an area which is less than or equal to 20% or less than or equal to 10% of the total area.

To perform the switching movement, the movable contact can be connected to a shaft, the shaft protruding through an opening in the switching chamber. As described below, the shaft can preferably be part of a magnetic drive or a motor drive.

According to a further embodiment, the switching chamber base has an opening for the passage of such a shaft of the switching device. The web structure can have a collar structure formed on the bottom surface and thus raised above the bottom regions, which surrounds the opening. As a result, the collar structure can form a channel which preferably extends in a vertical direction and in which the shaft can be guided. The collar structure can, for example, be formed by an essentially hollow cylindrical elevation, which can also be directly adjacent to one or more webs. In other words, the collar structure can merge into one or more webs. For example, a web, such as a longitudinal web or a transversal web, can be interrupted by the opening and thus by the collar structure. The collar structure can have a height that is at least equal to the height of at least one web. Preferably, the collar structure has a height that is equal to or, more preferably, greater than the height of all the webs of the web structure. Furthermore, the collar structure can have an top side, viewed in the vertical direction, which is designed as a mechanical stop for a movable part of the switching device or as a counter bearing for a spring.

According to a further embodiment, the switching chamber base has a peripheral edge structure that surrounds the bottom surface with the web structure. The edge structure is particularly preferably raised above the bottom regions, so that the bottom surface is surrounded by the circumferential, raised edge structure. Preferably, the edge structure has a height that is at least as great as a maximum height of the web structure. This can mean that the edge structure has a height that is equal to or greater than the height of the at least one web and particularly preferably equal to or greater than the height of all the webs of the web structure.

For example, the edge structure can be stepped and have an inner edge part with a first height and an outer edge part with a second height, whereby the first height is greater than the second height. The inner edge part can be directly adjacent to the outer edge part and surrounded by the outer edge part. For example, the outer edge part can have a support surface for the switching chamber cover, while the inner edge part rests against an inner side of the switching chamber cover when the switching chamber cover is fitted. The edge structure can, for example, have a height that is equal to the height of the collar structure. If the edge structure has regions with different heights, such as the inner edge part and the outer edge part, the height of the edge structure denotes its maximum height, i.e. the first height in the example mentioned.

Furthermore, the edge structure can have at least one spring element. The at least one spring element can, for example, be part of the outer edge part and form at least part of the contact surface for the switching chamber cover. The at least one spring element can, for example, be in the form of a leaf spring and exert a force on the switching chamber cover when the switching device is assembled. In particular, the switching chamber base can have several spring elements as parts of the outer edge part.

According to a further embodiment, the switching chamber base has, on an outer side opposite the inner side, a sleeve-shaped guide region for guiding the shaft in the opening. In other words, the guide region is preferably formed by an essentially hollow cylindrical elevation on the outside of the switching chamber base, through which a channel leads, which preferably continues into the channel formed by the collar structure. The opening in the switching chamber base is thus formed by the channel, which extends through the sleeve-shaped guide region and the collar structure. The shaft for moving the movable contact can be guided through this channel.

A bottom side of the guide region facing away from the collar structure can be configured as a mechanical counter-bearing or as a mechanical stop for a spring of the switching device. Furthermore, the switching device can have a fixed yoke, which can be part of a magnetic drive and above which or directly on which the switching chamber base can be arranged. The sleeve-shaped guide region can protrude into an opening of the yoke. This makes it possible, for example, for the shaft to be mechanically guided not by the yoke but by the guide region and the collar structure of the switching chamber base.

According to a further embodiment, the switching chamber base has a ventilation channel that extends from the outside of the switching chamber into the interior. Preferably, the ventilation channel opens into a ventilation opening in the collar structure. Particularly preferably, the ventilation opening in the interior of the switching chamber is arranged in a vertical direction at least partially on a top side of the collar structure. Furthermore, the ventilation opening is particularly preferably arranged at a distance from the bottom surface. In other words, the ventilation opening is located at a certain height above the bottom regions, in particular at a height of greater than or equal to 0.5 mm or greater than or equal to 1 mm. This can prevent loose parts such as melting beads from entering the aeration channel. The ventilation channel can thus form a protected ventilation port through which, for example, the switching chamber can be quickly filled with a gas, while the risk of contamination or blockage of the ventilation channel during operation is minimized. In particular, the ventilation channel can also be separate from the channel leading the shaft in the collar structure, so that even in the event of contamination or blockage of the ventilation channel, there is no risk of impairing the shaft movement. A ventilation groove can be provided on an outer side of the sleeve-shaped guide region, which merges into the ventilation channel. Furthermore, there can be several ventilation channels and ventilation grooves to which the aforementioned applies.

The switching chamber base described here can avoid problems that could occur in known switching devices, for example due to melting beads. The switching chamber base forms a specially shaped shield which can catch melting beads, for example in honeycombs, and can enable rapid evacuation and filling of the switching chamber by means of one or more additional, shielded ventilation channels. The switching chamber base, which can have the primary task of preventing arcs from reaching underlying parts such as a flange, is particularly preferably made of a high-melting plastic as described above. If the switching device is switched off under load, an arc is preferably deflected by blowing magnets and driven out of the contact area between the switching contacts. If the arc reaches the switching chamber base, additional hydrogen can be released, especially in the case of POM as the switching chamber base material, but also in the case of PBT or PA, so that rapid arc extinction can be achieved. If melting beads are formed due to burn-off of the contact materials, the web structure can prevent them from moving around uncontrollably on the switching chamber base. The special shape of the ventilation channel(s) also prevents the melt beads from blocking the shaft while maintaining a sufficient pump cross-section so that, for example, the switching chamber can be effectively filled with a gas during production.

The switching chamber base, which can be manufactured at essentially the same cost as conventional switching chamber bases, thus offers an easy-to-implement replacement solution for existing designs, which can lead to an extension of the service life of the switching device.

### BRIEF DESCRIPTION OF THE DRAWINGS

Further advantages, advantageous embodiments and further developments are revealed by the embodiments described below in connection with the figures.

FIGS. 1A to 1J show schematic illustrations of a switching device with a switching chamber according to an embodiment; and

FIGS. 2A to 2C show schematic illustrations of a switching device with a switching chamber according to a further embodiment.

In the embodiments and figures, identical, similar or identically acting elements are provided in each case with the same reference numerals. The elements illustrated and their size ratios to one another should not be regarded as being to scale, but rather individual elements, such as for example layers, components, devices and regions, may have been made exaggeratedly large to illustrate them better and/or to aid comprehension.

### DETAILED DESCRIPTION OF ILLUSTRATIVE EMBODIMENTS

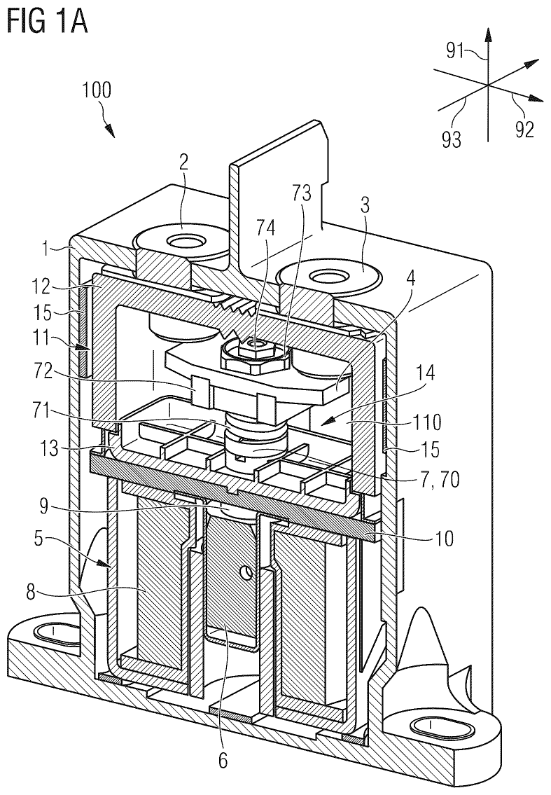

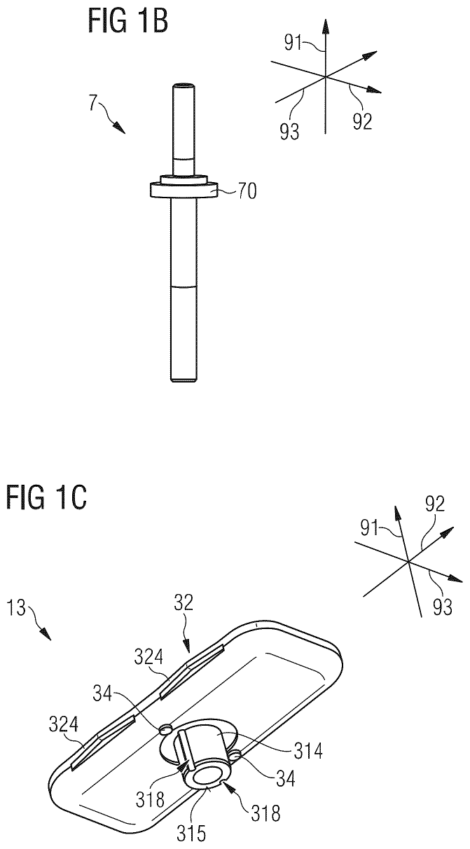

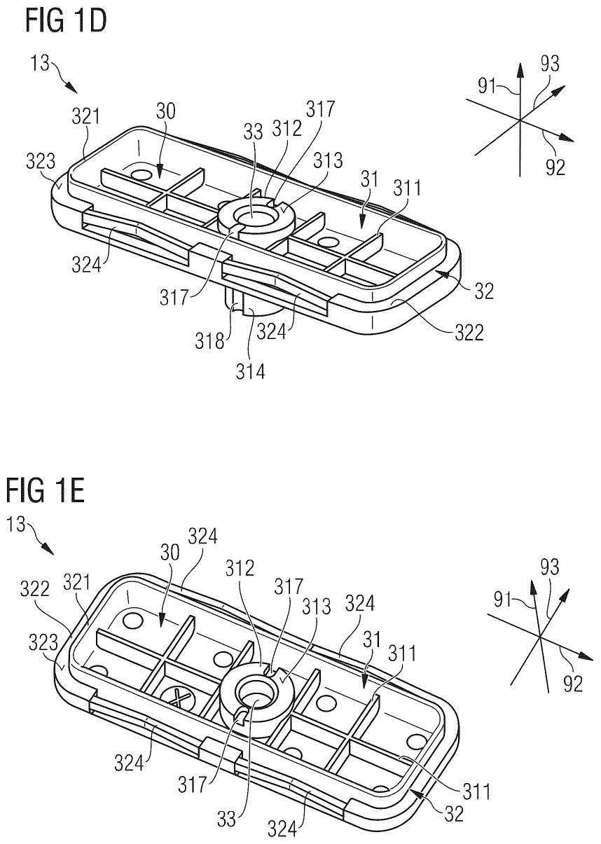

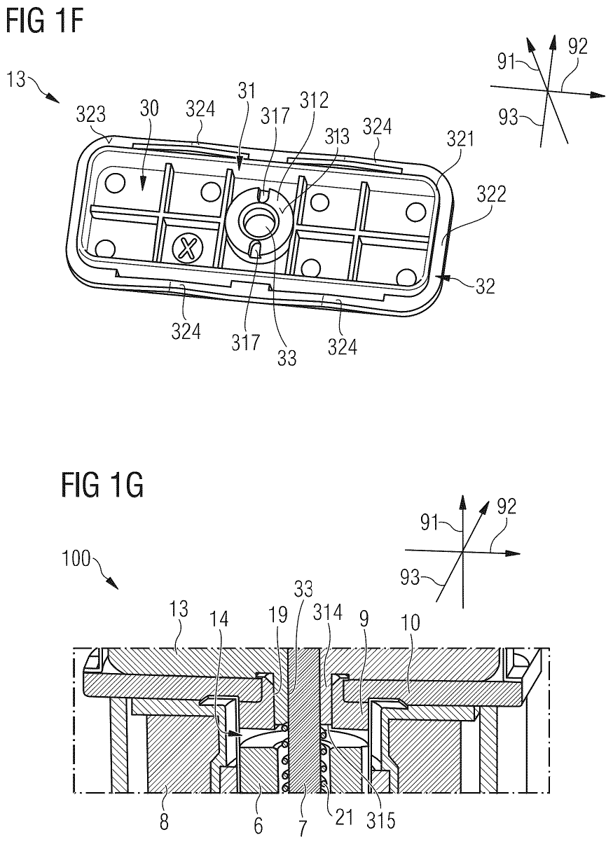

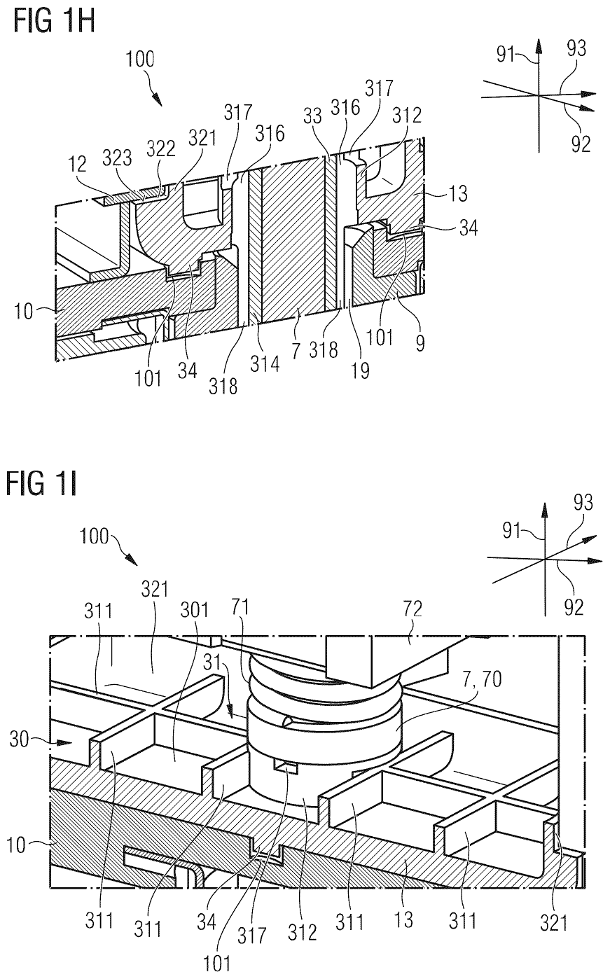

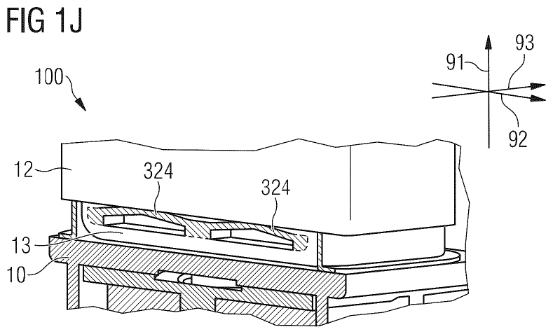

FIGS. 1A to 1J show various views of an embodiment of a switching device 100 with a switching chamber 11 and parts thereof. The switching device 100 can be used, for example, for switching strong electrical currents and/or high electrical voltages and can be a relay or contactor, in particular a power contactor.

FIG. 1A shows a three-dimensional sectional view of the switching device 100 with the switching chamber 11. FIG. 1B shows the shaft 7 individually. FIGS. 1C to 1F show various individual views of the switching chamber base 13 of the switching chamber 11. In FIGS. 1G to 1J, sections of the switching device 100 are shown in order to emphasize various details. The following description refers equally to FIGS. 1A to 1J. The geometries shown are only exemplary and are not to be understood as limiting and can also be designed alternatively.

The switching device 100 has two fixed contacts 2, 3 and a movable contact 4 in a housing 1. The movable contact 4 is configured as a contact plate that electrically connects the fixed contacts 2, 3 in a switched-on state of the switching device 100. The fixed contacts 2, 3 together with the movable contact 4 form the switching contacts. The housing 1 serves primarily as touch protection for the components arranged inside and has a plastic material or is made of it, for example polybutylene terephthalate (PBT) or glass-filled PBT. The contacts 2, 3, 4 can, for example, be made of or with Cu, a Cu alloy or a mixture of copper with at least one other metal, for example Wo, Ni and/or Cr.

The contacts 2, 3, 4 are arranged in a switching chamber 11, which is formed by a switching chamber cover 12 and a switching chamber base 13. In the embodiment shown, the switching chamber cover 12 is made of a ceramic material, for example with or made of a metal oxide such as Al₂O₃. The fixed contacts 2, 3 protrude into the switching chamber 11 through openings in the switching chamber cover 12 and are soldered into the openings, for example.

In FIG. 1A, the switching device 100 is shown in a rest state, in which the movable contact 4 is spaced apart from the fixed contacts 2, 3, so that the contacts 2, 3, 4 are electrically isolated from each other. The shown design of the switching contacts and in particular their geometry are purely exemplary and should not be understood as limiting. Alternatively, the switching contacts can also be embodied differently. For example, it is possible that only one of the switching contacts is fixed. In the switched-on state of the switching device 100, which in the embodiment shown is achieved by moving the movable contact along a vertical direction 91, the movable contact 4 is in contact with both fixed contacts 2, 3. Alternatively, the movable contact 4 could also be configured as a rotary contact, for example, which is mounted rotatably about an axis of rotation along the vertical direction 91 to complete the switching movement. The position of the switching device 100 shown in FIG. 1A corresponds to the intended installation direction. Unless otherwise specified, terms such as “up” and “down” used in the following refer to the vertical direction 91 and the intended installation direction.

In the embodiment shown, the arrangement direction of the fixed contacts 2, 3 defines a longitudinal direction 91, the direction perpendicular to the vertical direction 91 and to the longitudinal direction 92 is referred to below as the transversal direction 93. In FIGS. 1A to 1J, the directions 91, 92, 93 are indicated for easier orientation.

In the embodiment shown, the switching device 100 has a magnetic drive for moving the movable contact 4 to complete the switching movement. Alternatively, a motor drive could also be provided, for example. The magnetic drive has a movable armature 5, which essentially performs the switching movement along the vertical direction 91. The armature 5 has a magnetic core 6, for example with or made of a ferromagnetic material. Furthermore, the armature 5 has a shaft 7, which is shown individually in FIG. 1B. The shaft 7 is guided through a part of the magnetic core 6, as can be seen in FIG. 1G, and is firmly connected to the magnetic core 6 at one end of the shaft. At the other end of the axis, opposite the magnetic core 6, the armature 5 has the movable contact 4.

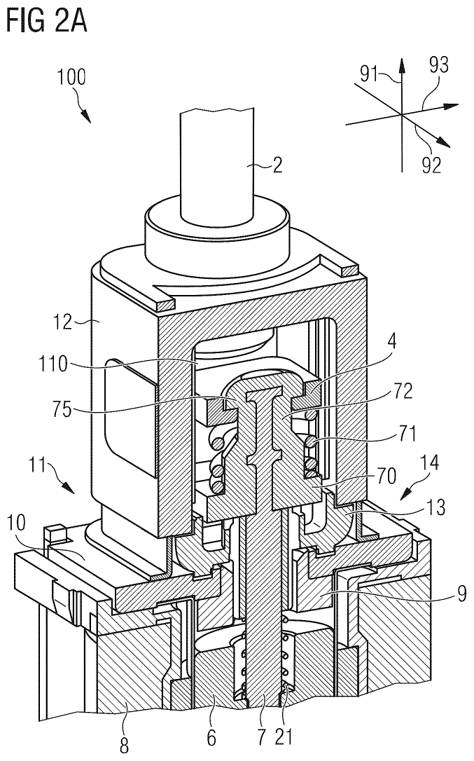

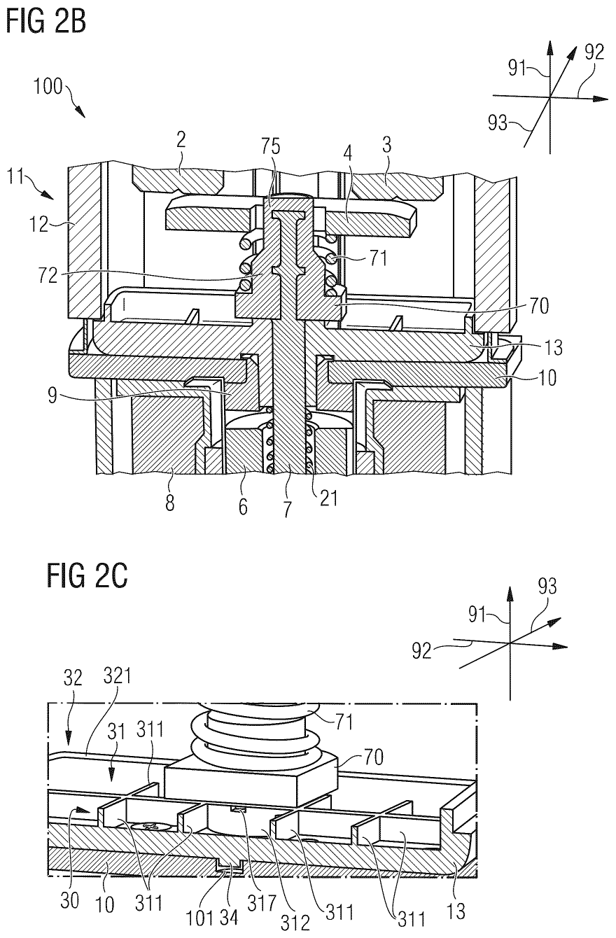

The one-piece shaft 7 can be made with or of stainless steel, for example, and in the embodiment shown, as shown in FIG. 1B, has an integral support element 70 in the form of a disk-like region. In the embodiment shown, the movable contact 4 is displaceably mounted on the shaft 7 above the support element 70 by means of a contact spring 71 and an electrically insulating bridge holder 72, for example with or made of PBT or PA. On the contact side of the movable contact 4, i.e. on the top side as seen in the vertical direction 91, the movable contact 4 is secured to the shaft 7 by means of an electrically insulating intermediate washer 73, for example with or made of PBT or PA, and a fastening nut 74. The shown mounting and fastening of the movable contact 4 to the shaft 7 is not to be understood limiting and can also be embodied differently, as described in connection with FIGS. 2A to 2C.

The magnetic core 6 is surrounded by a coil 8, which forms another part of the magnetic drive. An externally switchable current flow in the coil 8 generates a movement of the magnetic core 6 and thus of the entire armature 5 in the vertical direction until the movable contact 4 makes contact with the fixed contacts 2, 3. Parts of a control board for controlling the coil 8 are indicated on the right outer side of the coil in FIG. 1A. When the coil 8 is switched on, the armature 5 moves from a first position, which corresponds to the rest state shown in FIG. 1A and at the same time to the disconnecting, i.e. non-through-connecting, state, to a second position, which corresponds to the active, i.e. through-connecting, state. In the active state, the contacts 2, 3, 4 are galvanically connected to each other. In another embodiment, the armature 5 can, as mentioned above, alternatively also perform a rotary movement, for example. In particular, the armature 5 can also be configured as a pull armature or hinged armature.

Furthermore, the magnetic drive of the switching device 100 has a yoke 9 which can comprise or be pure iron or a low doped ferrous alloy and which forms part of the magnetic circuit. The yoke 9 has an opening 19, as can be seen in FIGS. 1G and 1H, through which the shaft 7 is passed. If the current flow in the coil 8 is interrupted, the armature 5 is moved back to the first position by one or more springs 21, indicated in FIG. 1G. The switching device 100 is then back in the rest state, in which the contacts 2, 3, 4 are open.

The yoke 9 is surrounded by a flange 10, which separates the switching chamber 11 from the lower part of the switching device 100 in which, among other things, the magnetic core 6 and the coil 8 are located. The flange 10, which can form part of the magnetic circuit, can be made with or of iron such as pure iron or a low-doped iron alloy, like the yoke 9, and can also be formed integrally with the yoke 9.

Opening the contacts 2, 3, 4 can cause an electric arc that can damage the contact surfaces. As a result, there is a risk that the contacts 2, 3, 4 can “adhere” to each other due to welding caused by the arc and can no longer be separated from each other. In order to prevent the formation of such arcs or at least to support the extinguishing of arcs that occur, the contacts 2, 3, 4 are arranged in a gas atmosphere, so that the switching device 100 is configured as a gas-filled relay or gas-filled contactor. For this purpose, the contacts 2, 3, 4 are arranged within the switching chamber 11, formed by the switching chamber cover 12 and the switching chamber base 13, in a gas-tight region 14 within the housing 1. In particular, the switching chamber cover 12 is part of the wall enclosing the gas-tight region 14. The gas-tight region 14 completely contains the armature 5 and an interior 110 of the switching chamber 11. The gas-tight region 14 and thus, inter alia, the switching chamber 11 are filled with a gas. The gas, which can be filled through a gas filling nozzle (not shown), for example in the lower region of the gas-tight region 14, as part of the manufacture of the switching device 100, can particularly preferably contain hydrogen. In particular, the gas 14 can comprise at least 50% or more H₂ in an inert gas such as N₂ and/or one or more noble gases, since hydrogen-containing gas can promote the extinguishing of electric arcs. As can be seen in FIG. 1A, one or more blowing magnets 15 can additionally be arranged at the switching chamber 11, or alternatively also within the switching chamber 11, i.e. preferably permanent magnets, which can cause an extension of the arc gap and a deflection of the arcs from the area between the contacts 2, 3, 4.

As can be seen in FIG. 1G, the upper part of the gas-tight region 14, which is located above the flange 10 and in which the contacts 2, 3, 4 are located in the switching chamber 11, is connected to the lower part of the gas-tight region 14, which is located below the flange 10 and in which the magnetic core 6 of the armature 5 is located, only through the opening 19 in the yoke 9, through which the shaft 7 is passed. In order to achieve, for example, fast pumping times when filling the gas-tight region 14 and to ensure gas exchange between the upper part and the lower part during switching operations, it is necessary that a sufficient gas flow is possible through the opening 19 in the yoke 9. On the other hand, as described in the general part, melting beads can be produced in the event of arc-induced burning of the contacts 2, 3, 4, which in turn, if they were to enter the opening 19 or the lower part of the gas-tight region 14, would run the risk of hindering or even blocking the mobility of the mechanical parts, which should therefore be prevented. The switching chamber 11 with the switching chamber base 13, which is described in more detail below, is designed in such a way that both requirements can be met.

In the embodiment shown, the switching chamber cover 12 is cap-shaped and can be made in one piece or in several parts. The switching chamber base 13, which is shown individually in FIGS. 1C to 1F from several angles, is of plate-like design and is manufactured in one piece. The switching chamber cover 12 and the switching chamber base 13 enclose the interior 110 in which the switching operations take place. As an alternative to the embodiment shown, the switching chamber base 13 can, for example, also have a cap-shaped design, i.e. essentially have a higher edge.

The switching chamber base 13 preferably has a plastic material, particularly preferably a plastic material from which hydrogen can be released when heated. In particular, the plastic material is configured in such a way that hydrogen can be released by an electric arc that strikes the plastic material, so that the additionally released hydrogen, particularly preferably in the form of H₂, can lead to an improvement in arc extinction. The plastic material can be polyoxymethylene (POM), for example. Alternatively or additionally, polybutylene terephthalate (PBT) and/or polyamide (PA), in particular PA46, can also be used as the plastic material. Furthermore, the plastic material can contain a filler, in particular a glass material, for example in the form of glass fibers, dispersed in the plastic material. Particularly preferably, the plastic material has a filler content, for example a glass fiber content, of less than or equal to 50%, based on the mass. Particularly preferably, the plastic material is selected by selecting a suitable polymer and by selecting a suitable proportion of a filler, such that it has sufficient mechanical and thermal stability under usual operating conditions of the switching device 100. Furthermore, the switching chamber base 13 can have a softening temperature or melting temperature which is selected such that contact material which is still hot and which gets onto the switching chamber base 13, for example in the form of melting beads, as a result of arc-induced burn-off of the switching contacts, can soften the plastic material so that, for example, melting beads can at least partially melt into the switching chamber base 13, as a result of which the freedom of movement of melting beads can be restricted. For example, the material of the switching chamber base 13 can have a melting temperature of greater than or equal to 250° C. and less than or equal to 350° C.

On the inner side facing the interior 110 of the switching chamber, the switching chamber base 13 has a bottom surface 30 with a web structure 131 which protrudes out of the bottom surface 30 into the interior. The bottom surface 30 is the area of the switching chamber base 13 on the inside, which is surrounded by a circumferential edge structure 32 that is raised in the embodiment shown.

The web structure 31 protrudes from the bottom surface 30 in relief and has at least one web 311 that extends over the bottom surface 30. The web structure 31 is configured such that the freedom of movement of loose parts such as melting beads on the switching chamber base 13 can be reduced.

In the embodiment shown, the web structure 31 has a plurality of webs 311 and is configured such that the bottom surface 30 has a plurality of bottom regions 301 separated from one another by the web structure 31. For the sake of clarity, not all webs are provided with a reference numeral in FIGS. 1D to 1F. A loose part such as a fused bead can preferably be prevented by the web structure 31 from moving from one bottom region 301 to a bottom region 301 separated therefrom, at least under normal operating conditions, so that the freedom of movement of fused beads on the bottom surface 30 of the switching chamber base 13 can be restricted, at least under normal operating conditions. Preferably, the bottom regions 301 separated from each other lie in the same plane and thus define this plane, which is preferably aligned perpendicular to the vertical direction 91, whereby the bottom surface 30 would be flat without the web structure 31.

The web structure and in particular the webs 311 preferably have a height of greater than or equal to 0.5 mm and less than or equal to 5 mm and preferably greater than or equal to 1 mm and less than or equal to 3 mm, wherein height specifications, unless otherwise indicated, refer to a distance measured in the vertical direction 91 from a bottom region 301. A height in the indicated ranges can effectively restrict the freedom of movement of fused beads, which typically have an average size of 0.5 mm to 1 mm, without the web structure 31 requiring too much space in the vertical direction.

As shown, the web structure 31 has intersecting webs 311 extending, for example, in the longitudinal direction 92 and in the transversal direction 93. As shown, the web structure 31 can have at least one web 311 in the longitudinal direction and two or more webs 311 extending transversely thereto, for example webs 311 extending along the transversal direction, which intersect. As shown, the web structure 31 can have, for example, one longitudinal web and four transversal webs. In addition, the web structure 31 can also have one or more webs extending at an angle to the longitudinal direction 92 and transversal direction 93. Due to the intersecting webs 311, the web structure 31 can form a honeycomb structure, for example with rectangular honeycombs as shown or alternatively also with hexagonal honeycombs, for example. The web structure 31 divides the bottom surface 30, which has a total area, into a plurality of bottom regions 301 separated from each other, each of the plurality of bottom regions 301 preferably having an area which is preferably less than or equal to 20% or less than or equal to 10% of the total area.

As described above, the switching chamber base 13 has an opening 33 for passage of the shaft 7 of the switching device 100. The web structure 31 has a collar structure 312 raised above the bottom regions 301 of the bottom surface 30, which surrounds the opening 33. As a result, the collar structure 312 forms a channel in the vertical direction 91 in which the shaft 7 can be guided. For example, as shown, the collar structure 312 is formed by a substantially hollow cylindrical elevation which can directly adjoin one or more webs 311 such that the collar structure 312 merges with one or more webs 311. As shown, for example, the longitudinal web can be interrupted by the opening 33 and thus by the collar structure 312. The collar structure 312 preferably has a height that is at least equal to the height of the webs 311 or, as shown, greater than the height of the webs 311.

Furthermore, the collar structure 312, as seen in the vertical direction 91, has a top side 313, which is formed as a mechanical stop for the support element 70 of the shaft 7, as can be seen, for example, in FIG. 1I.

Furthermore, the switching chamber base 13 has a sleeve-shaped guide region 314 on an outer side opposite the inner side for guiding the shaft 7 in the opening 33. The sleeve-shaped guide region 314 is formed by a substantially hollow cylindrical elevation on the outside of the switching chamber base 13, through which a channel leads, which preferably continues into the channel formed by the collar structure 312. The opening 33 in the switching chamber base 13 is thus formed by the continuous channel, which passes through the sleeve-shaped guide region 314 and through the collar structure 312. The shaft 7 for moving the movable contact 4 is guided in this channel. The sleeve-shaped guide region 314 further projects into the opening 19 of the yoke 9, as can be seen in FIGS. 1G and 1H. In this way, it can be achieved that the shaft 7 is not mechanically guided by the yoke 9 but by the guide region 314 and the collar structure 312 of the switching chamber base 13. A bottom side 315 of the sleeve-shaped guide region 314 facing away from the collar structure is designed as a mechanical counter-bearing for the spring 21 of the switching device 100, as can be seen in FIG. 1G.

According to a further embodiment, the switching chamber base 13 has at least one ventilation channel 316. As can be seen, for example, in FIG. 1H, the switching chamber base 13 in the embodiment shown has two ventilation channels 316, which are arranged in the transversal direction on both sides of the opening 33. Furthermore, additional ventilation channels or only one ventilation channel can be present. Each of the ventilation channels 316 extends from the outside of the switching chamber 11 into the interior 110. In particular, each of the ventilation channels 316 opens into the interior 110 with a ventilation opening 317 in the collar structure 312. The ventilation openings 317 are arranged in the interior 110 of the switching chamber 11 in the vertical direction partially on the top side 313 of the collar structure 312, in particular in the region of the circumferential edge of the top side 313, so that the ventilation openings 317 remain at least partially unobstructed even when the support element 70 of the shaft 7 rests on the top side 313 of the collar structure 312, as can be seen in FIG. 1I. The collar structure 312 thus has a circumferential shoulder between the ventilation openings 317, which ensures that the ventilation openings 317 are openly accessible regardless of the switching state of the switching device 100.

Further, the ventilation openings 317 are spaced apart from the bottom surface 13. In other words, the ventilation openings 317 are located at a certain height above the bottom regions 301, in particular at a height of greater than or equal to 0.5 mm or greater than or equal to 1 mm. For example, the lower edge of the ventilation openings 317 can be arranged at a height corresponding to a height of the webs 311. The raised arrangement of the ventilation openings 317 can prevent loose parts such as melting beads from entering the ventilation channels 316. Furthermore, the aeration channels 316 are also separate from the channel in the collar structure 312 guiding the shaft 7, as can be seen in FIG. 1H, so that even in the event of contamination or blockage of a ventilation channel 316, there is no fear of impairment of the shaft movement. The ventilation channels 316 can thus form protected ventilation nozzles through which, for example, the switching chamber 11 can be quickly filled with a gas, while the risk of contamination or blockage of the ventilation channels 316 and impairment of the mobility of the shaft 7 during operation is minimized. Ventilation grooves 318 can further be provided on an outer side of the sleeve-shaped guide region 314, each of which merges into a ventilation channel 316, as can be seen in FIG. 1H.

The web structure 31, in particular the honeycomb structure formed thereby, can prevent molten beads from entering the guide of the shaft 7, which is formed by the collar structure 312 and the sleeve-shaped guide element 314, and into the lower part of the switching device 100. The raised arrangement of the ventilation openings 317 can make this even more difficult. The shoulder in the collar structure allows a sufficient pump cross-section and gas exchange even with flush-mounted components on the top side 313 of the collar structure 312.

Furthermore, adjustment elements 34 in the form of cylindrical or disc-shaped projections are provided on the outside of the switching chamber base 13, which engage in corresponding adjustment elements 101 in the form of matching recesses when the switching chamber base 13 is arranged on the flange 10 as intended. This makes it easy to achieve correct positioning of the switching chamber base 13 on the flange 10. As an alternative to the embodiment shown, the adjustment elements 34, 101 can also be designed differently, in which case they also preferably engage with one another.

Furthermore, as mentioned further above, the switching chamber base 13 has the circumferential edge structure 32 which surrounds the bottom surface 30 with the web structure 31. As shown, the edge structure 32 is particularly preferably raised above the base regions 301, so that the bottom surface 30 is surrounded by the circumferential raised edge structure 32. Preferably, the edge structure 32 has a height that is greater than the height of the webs 311 of the web structure 31.

As shown, the edge structure 32 can particularly preferably be step-shaped and have an inner edge part 321 with a first height and an outer edge part 322 with a second height, wherein the first height is greater than the second height. The inner edge part 321 is directly adjacent to the outer edge part 322 and is surrounded by the outer edge part 322. The outer edge part 322 has a support surface 323 for the switching chamber cover 12, whereas the inner edge part 321 rests against an inner side of the switching chamber cover 12 when the switching chamber cover 12 is mounted, as can be seen in FIGS. 1H and 1J. The edge structure 32 can particularly preferably have a height that is equal to the height of the collar structure 312. If the edge structure 32 has regions with different heights, such as the described inner edge part 321 and outer edge part 322, the height of the edge structure 32 denotes its maximum height, in this case the first height.

Furthermore, the edge structure 32 has spring elements 324, which are parts of the outer edge part 322. Instead of the four spring elements 324 shown, there can also be more or fewer spring elements. The spring elements 324 can, for example, be in the form of leaf springs and exert a force on the switching chamber base 12 when the switching chamber 11 is assembled, so that the switching chamber base 13 can be held between the switching chamber base 12 and the flange 10 by a clamping force without further fastening measures.

FIGS. 2A to 2C show sections of the switching device 100 according to a further embodiment in which, in comparison to the previous embodiment, the armature 5 has a bridge holder 72 which, unlike in the previous embodiment, is firmly connected to the shaft 7.

The bridge holder 72 is formed on the shaft 7 and, compared to the previous embodiment, comprises the support element 70. The contact spring 71 is supported on the support element 70 and directly on the underside of the movable contact 4. As can be seen in FIG. 2A, the bridge holder 72 further has an armature part 75 with latching lugs, which form a bayonet lock with a suitably shaped opening in the movable contact 4. By inserting the armature part 75 into the opening of the movable contact 4 and rotating the movable contact 4, for example by 90°, the movable contact 4 can be locked onto the bridge holder 72. Further features and embodiments of the bridge holder of the embodiment of FIGS. 2A to 2C are described in publication WO 2020/187586 A1, which content is incorporated herein by reference in its entirety.

The previously described design of the switching chamber base 13 and in particular the ventilation openings can achieve continuous ventilation of the switching chamber 11 regardless of the specific shape of the bridge holder and in particular of the support element.

The features and embodiments described in connection with the figures can be combined with one another according to further embodiments, even if not all combinations are explicitly described. Furthermore, the embodiments described in connection with the figures can alternatively or additionally have further features as described in the general part.

The invention is not limited to the description based on the embodiments. Rather, the invention includes any new feature as well as any combination of features, which includes in particular any combination of features in the patent claims, even if this feature or combination itself is not explicitly stated in the patent claims or embodiments.

1.-20. (canceled)

21. A switching chamber for a switching device, the switching chamber comprising:
at least a switching chamber base comprising:
on an inner side facing an interior of the switching chamber, a bottom surface with a web structure, which projects out of the bottom surface into the interior.

22. The switching chamber according to claim 21, wherein the bottom surface comprises a plurality of bottom regions separated from each other by the web structure.

23. The switching chamber according to claim 22, wherein the bottom surface has a total area and each of the plurality of bottom regions has an area that is less than or equal to 20% of the total area.

24. The switching chamber according to claim 21, wherein the web structure comprises at least one web separating at least two bottom regions from each other.

25. The switching chamber according to claim 24, wherein the at least one web has a height of greater than or equal to 0.5 mm and less than or equal to 5 mm.

26. The switching chamber according to claim 21, wherein the web structure forms a honeycomb structure.

27. The switching chamber according to claim 21, wherein the switching chamber base comprises an opening for passage of a shaft of the switching device, and wherein the web structure comprises a collar structure raised above the bottom surface and surrounding the opening.

28. The switching chamber according to claim 27, wherein the collar structure has a height that is greater than a height of at least one web of the web structure.

29. The switching chamber according to claim 27, wherein the bottom surface is surrounded by a circumferential raised edge structure, and wherein the edge structure and the collar structure have an equal height.

30. The switching chamber according to claim 29,
wherein the edge structure comprises an inner edge part having a first height and an outer edge part having a second height,
where the first height is greater than the second height,
wherein the outer edge part has a support surface for a switching chamber cover of the switching chamber, and
wherein the edge structure comprises at least one spring element which is part of the support surface.

31. The switching chamber according to claim 21, wherein the bottom surface is surrounded by a circumferential raised edge structure, and wherein the edge structure has a height being greater than the height of at least one web of the web structure.

32. The switching chamber according to claim 21, wherein the switching chamber base comprises spring elements, which are part of an outer edge part, and which are in form of leaf springs.

33. The switching chamber according to claim 21, wherein the switching chamber base has a sleeve-shaped guide region, arranged on an outer side opposite the inner side, configured for guiding a shaft of the switching device.

34. The switching chamber according to claim 33, further comprising a ventilation channel arranged on an outer side of the sleeve-shaped guide region, which merges into the ventilation channel.

35. The switching chamber according to claim 21, further comprising a ventilation channel extending from an outside of the switching chamber into the interior and opening into the interior with a ventilation opening in a collar structure of the web structure.

36. The switching chamber according to claim 35, wherein the ventilation opening is arranged in the interior of the switching chamber at a top side of the collar structure.

37. The switching chamber according to claim 34, wherein the ventilation opening is arranged at a distance from the bottom surface.

38. The switching chamber according to claim 21, wherein the switching chamber base is formed integrally from a plastic material, wherein the plastic material comprises one or more materials selected from polyoxymethylene, polybutylene terephthalate and polyamide, or a glass fiber content of less than or equal to 50%.

39. The switching device comprising:
the switching chamber according to claim 21; and
at least one fixed contact and a movable contact in the switching chamber,
wherein the switching chamber contains a gas comprising H₂.

40. The switching device according to claim 39, further comprising a magnetic drive with a shaft, which projects into the switching chamber through an opening in the switching chamber base,
wherein the magnetic drive has a fixed yoke above which the switching chamber is arranged, and
wherein the switching chamber base has, on an outer side facing away from the interior of the switching chamber, a sleeve-shaped guide region which projects into an opening of the yoke.
